(19) United States
(12) Patent Application Publication
(10) Pub. No.: US 2016/0066743 A1
(43) Pub. Date: Mar. 10, 2016

(54) Cooking Pot with Straining Lid and Spoon Support

(71) Applicants: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(72) Inventors: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(21) Appl. No.: 14/482,012

(22) Filed: Sep. 10, 2014

(51) Int. Cl. A47J 36/08; A47J 43/28; A47J 27/00

(52) U.S. Cl. CPC A47J 36/08; A47J 27/002; A47J 43/287

(57) ABSTRACT

A pot comprises a cooking vessel with handle. The vessel has an upper edge at the top of its side wall and a pouring spout formed therein. A lid is provided, having a downwardly extending flange extending inwardly and downwardly therearound for snuggly fitting the lid within the side wall of the vessel. It is provided with a handle. The flange has a strainer section. When the strainer is aligned with the pouring spout, the liquid contents of the pot can be poured while the solid contents remain. The flange extends into the pot a sufficient depth so that the pot and lid can be tilted for pouring and, yet, the lid held on the pot. The pot's handle comprises a preferably concave top surface to hold a standard-sized handle of a cooking spoon. The lid is provided with a central recess for a spoon head to sit thereon.

### FIELD OF THE INVENTION

The present invention relates to a cooking pot for home kitchen cooking having a cover with an integrated colander segment, a mechanism to lock the cover in place so that the colander is not accidentally aligned with the spout of the pot when maintaining the heat within the pot is desired and the cover also having a handle. The handle of the cover and the handle of the pot separately and together coordinate to provide a convenient spoon rest. The cover or lid is rotatable by its handle and, when the colander segment of the lid is aligned with the spout of the pot, the pot can be tilted for passing water through the colander segment (a strainer) and through and out the spout of the pot. When the colander segment and spout are not aligned, the cover is maintained on the pot and tilting of the pot will not result in significant removal of water through the spout. The handle of the pot serves as a convenient spoon rest as does the handle of the lid of the pot. Thus, the present invention relates to kitchenware, more specifically, a pot for cooking in a kitchen, where the pot can act as a colander for removal of water and where the pot, with a lid, has spoon resting surfaces.

### BACKGROUND OF THE INVENTION AND DISCLOSURE

For the preparation of many meals, a cook requires a pot and a stifling spoon. However, chefs with small kitchens often run into issues of space while cooking, and may not have a place to place down a spoon which has been used without dirtying their countertops. While individuals who love to cook dream of owning homes with large kitchens, multiple ovens, and an abundance of cook or counter top space, the reality is that many people do not have a lot of counter space, and kitchens are often quite small, often located in small homes, rooms, even in small apartments or dorms. Individuals with small kitchens often refrain from purchasing many kitchen appliances, either because they are bulky and difficult to store, or because the individual does not have the counter space for them during cooking. Thus, it is considered advantageous to provide a cooking vessel, namely a pot or pan, which also provides a holding location capacity for a cooking utensil, namely, a spoon.

Additionally, because of space constraints in small apartments, individuals often choose not to even purchase certain otherwise highly useful kitchen appliances, hoping to “make do” with what they have. One gadget or appliance, which is often not purchased because of its perceived bulkiness for storage purposes when not used and infrequent use, is a colander. Colanders are often round and take up a relatively large volume in a cabinet for storage. There have been collapsible colanders, too, but these still take up storage space. Thus, it would be advantageous to have a colander or strainer for removing fluid, usually water, from a pot which colander can be somehow cleverly integrated into another kitchen appliance (a pot or pan with a lid or cover) to reduce the amount of space required for storage of the same. Merely because a colander is bulky and a separate item to use and then clean, many cooks in the kitchen will avoid using the same and try to merely pour off fluid from the pot or pan, by simple tilting, hoping to retain the bulk of the food in the pot, i.e., the non fluid food. This however, requires skill and is not always successful.

Thus, the present invention comprises a pot or pan for cooking, and preferably comprises a closing cover with a pouring lip on the rim of the pot which has a strainer section, alignable with the spout of the pot, to allow liquid therein to be easily and accurately poured out of the pot. Most pots have a perfectly circular and continuous rim around the top edge thereof. However, the pot of the present invention is configured with a pouring spout located in the rim of the pot, much like a pouring spout of a large skillet might have.

The cover or lid further comprises a downwardly extending flange segment, sort of an elongated lip, with a segment of that having water or fluid straining holes. The lid is configured to securely fit within the circumference of the pot. When the strainer segment is not aligned with the spout, the cover or lid closes off the contents of the pot to prevent hot air inside the pot from being released during cooking. This, of course, is efficient. When the strainer segment is aligned with the spout, accomplished by rotating the handle of the cover or lid into a precise orientation with respect to the pot handle, the pot and cover can be tilted together and the water poured out through the strainer, with the solid contents staying within the pot (at least to the extent they are larger than the holes of the strainer and do not float). The downwardly extending flange of the lid is preferably all around the cover and facilitates location of the cover on the pot and also, as mentioned, allows for fluid drainage when the strainer section of the flange aligns with the spout of the pot.

The strainer section represents only a section of the flange and is preferably just about equal in height and width to the pouring spout, allowing the contents of the pot to be strained and liquid removed, even while the lid is still on during cooking, and without risking the hot liquid from the pot pouring at a rapid pace and spilling and without risking the cover or lid from accidentally falling off during straining, i.e., during tilting of pot and lid thereon. The downwardly extending flange is configured in height with respect to the overall height of the pot so that maximum tilting of the pot can be done, with lid staying thereon, and, yet, most of the liquid will be capable of being poured off, as desired. During cooking, while a user wishes to keep all heat and steam within the pot, the lid can be placed on the pot so that of the solid section of the flange—which is preferably the majority of the flange—abuts the pouring spout to prevent heat from escaping the pot. Then, if the user wishes to strain the contents of the pot or pour out liquid therefrom, the user can merely rotate the lid so that the strainer or apertured portion is aligned with the pouring spout, and tilt the pot, such as over a sink or container, so that liquid can easily and accurately be poured therefrom. For example, when a user makes soup and wishes to separate the liquid broth from the meat and vegetables for serving purposes, the pot of the present invention allows ease of separation of liquid from solid, while reducing the risk of a user burning themselves attempting to do so. And, there is no need to hold the lid on the pot, either, as the depth of the flange is sufficient to hold the same on the pot, even during high angles of tilt for straining. The lid with colander section or segment of the present invention is advantageous because it can easily be stored within the geometric circumference of the pot (like most lids) thereby reducing the storage space required for a separate colander and the need for a separate colander.

Additionally, the pot of the present invention comprises a handle for holding and maneuvering the pot onto and off of a burner on the stove. However, the handle of the present inventive pot is configured to also serve as a spoon rest for a cooking spoon or other utensil being used during cooking. The longitudinal pot handle extends laterally from the pot, like most such handles, but further comprises a preferably concave top structure with the width thereof being large enough to hold a standard-sized round or flat handle for a cooking utensil. (like a spoon or spatula) For ease of discussion, standard-sized cooking utensils will be collectively referred to as a “cooking spoon.” A cooking spoon can be placed within the concavity formed by the interior side walls of the pot handle to hold the cooking spoon in place and preferably prevent the same from sliding off of the edge of the handle. The pot handle is also preferably long enough to hold a majority of the cooking spoon handle thereon to ensure that the center of gravity of the cooking spoon is securely on the handle, thereby preventing the cooking spoon from falling off and/or into the pot during cooking. A cooking spoon can preferably be held on the handle of the pot either with or without the lid placed over the pot.

In an alternate embodiment of the present invention, the lid or cover of the pot has its own handle (called the pot handle), which has a concave surface thereon for holding the downwardly convex portion of the spoon thereon. This further stabilizes the holding of the spoon on the pot, when the spoon is not being used. However, its location so near to the pot means that a cook will not be in search of the spoon, when needed.

Thus, the present invention combines and integrates the benefits of three common kitchen tools into a single pot and lid. Specifically, the pot of the present invention contains the structural features of a traditional pot for cooking, but also comprises the structural and functional features of a colander for straining liquid from a solid, and a spoon rest for holding a cooking utensil during cooking. The present invention is advantageous for cooking and for storage, as it requires fewer items to be used, cleaned, and stored.

### DESCRIPTION OF PRIOR ART

To the Applicant's knowledge, no prior art pots for cooking combine the structural features and functionality of a pot with lid, a colander or strainer, and a spoon rest. Thus, it is advantageous to provide a kitchen device which contains all of these components for the purpose of reducing the number of items to be purchased, used during cooking, cleaned, and also reducing the amount of space required for storage.

### SUMMARY OF THE INVENTION

The present invention comprises a pot for cooking that has a pouring spout located and extending outwardly from one side of the rim of the pot to allow liquid therein to be easily and accurately poured out of the pot. The pot also comprises a cover or lid with a downwardly extending flange that fits within the side wall of the pot. This seals off the interior cavity of the pot from the outside and holds the cover thereon. This flange extends to about no less than about 25% of the height of the sidewall of the pot, preferably about 33% or even 40%. In this manner, the cover will not accidentally fall off of the pot when the same, with cover, is highly tilted for pouring off of liquid.

A cover is provided which fits over the opening of the pot. It has, as mentioned, a downwardly extending flange. A segment of the flange is provided with a set of small fluid draining apertures so that the same acts as a sieve or strainer when the cover is on the pot and the cover and pot are simultaneously tilted. Fluid will drain through the apertures and the spout of the pot and solids kept behind the strainer and within the pot. Drainage can only occur when the aperture section of the flange is aligned with the spout section of the pot. This can be indicated to the user by aligning the strainer section with the longitudinal handle. When the lid handle is aligned with the side spout of the pot, the strainer is aligned with the pot spout, too. When the strainer is not aligned, tilting of the pot will not cause fluid to leave the pot. The strainer section is preferably at least equal in height and width to the pouring spout allowing the contents of the pot to be strained and liquid removed, even while the lid is still on during cooking, and without risking the hot liquid from the pot pouring out at a rapid pace and spilling. Preferably, the flange holding the strainer section is about 25% of the height of the pot's side wall so that the pot can be tilted and the lid maintained thereon.

Additionally, the pot lid comprises a handle for holding and maneuvering the same, and the pot has its own laterally extending holding handle. It comprises a preferably concave top surface with a width and length large enough to hold a standard-sized round handle for a cooking spoon, i.e., the spoon will nestle between the handle's upwardly extending curved side walls. This will preferably prevent the cooking spoon from sliding off of the edge of the handle because the center of gravity of the cooking spoon will preferably be securely on the handle.

In an alternate embodiment, the lid is provided with a concave section of its handle that can support the curved head of the spoon. However, even with the lid removed, the pot's handle can hold the spoon in a stable manner.

### BRIEF DESCRIPTION OF THE DRAWINGS

FIG. 1 is a top and front perspective view of the present invention, a pot with a lid having a flange and a strainer section acting as a colander and a spoon rest built into the pot's handle, with a cooking utensil, a spoon shown thereon;

FIG. 2 is a side elevational view of the pot, lid and spoon seen in FIG. 1;

FIG. 3 is a top perspective view of the pot seen in FIG. 1, with the lid having been removed therefrom but showing a spoon supported on the handle of the pot;

FIG. 4 is a top and front perspective view of the pot, lid and handle seen in FIG. 1, with the spoon having been removed from the handle;

FIG. 5 a top partial perspective view of the pot shown in FIG. 1, with the lid having been rotated so that the strainer of the downwardly extending and interior-located flange of the lid is aligned with the pouring spout for releasing liquid therefrom; and

FIG. 6 is a partial view of the lid, with interior pot-contacting flange and showing a section thereof provided with the strainer.

### DETAILED DESCRIPTION OF THE DRAWINGS AND THE PREFERRED EMBODIMENT

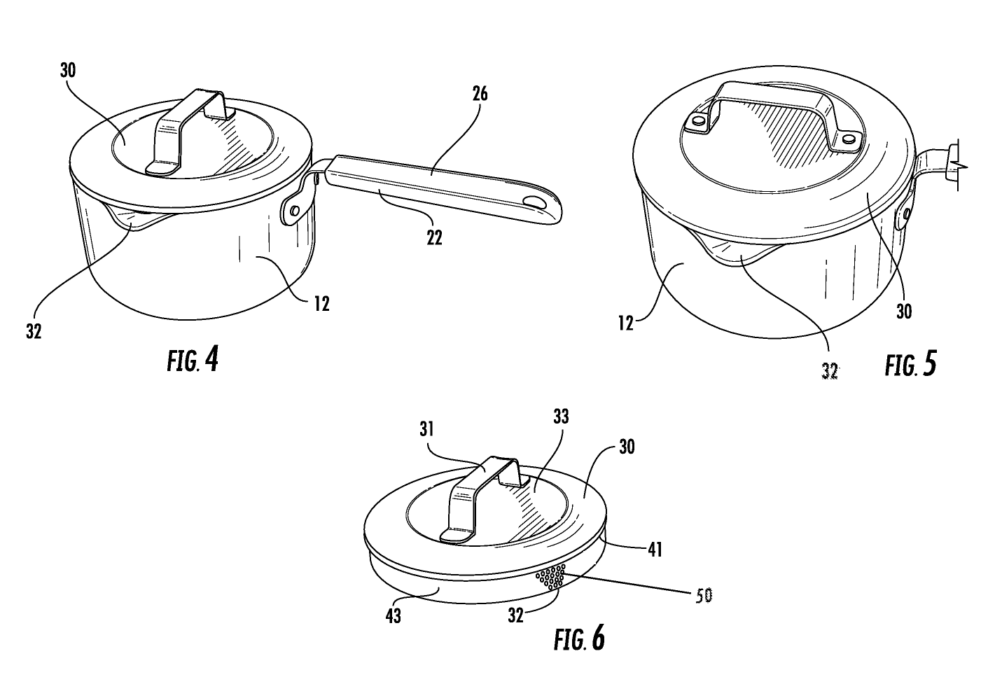

Description will now be given of the invention with reference to the attached FIGS. 1-6. It should be understood that these figures are exemplary in nature and in no way serve to limit the scope of the invention, as the invention will be defined by the claims, as interpreted by the Courts in an issued U.S. Patent.

As can be seen in the Figures, the present invention comprises a pot 10 for cooking food in a kitchen on a stove. The pot can be formed of any known material for cooking pots, e.g., steel, metal coated or not with Teflon®, aluminum, etc. Pot 10 comprises an open-top cavity or vessel 12 which has a bottom or base 13 which will sit over the heat for cooking. The base 13 extends upwardly to form a continuous cylindrical inside and outside wall 14. A rim or upper edge 18 is located at the top of wall 14. At least one location of rim 18 is bowed outwardly to form a pouring spout 16. In the embodiment shown, one such pouring spout is provided at the side of the vessel, determined by a position about 90 degrees from the pot-holding handle 20. Another pouring spout 24 could be located opposed to the pouring spout 16.

The pouring spout is conventional in shape but clearly configured to easily and accurately pour liquid from the vessel 12 into an alternative container. Pouring spout 16 is designed to limit the pouring of liquid from the vessel so that no liquid will pour over the upper edge 18 when the pot is tilted for pouring. Rather, the spout is a lower, located opening in the side wall of the pot in terms of elevational point of liquid discharge, quite conventionally.

Pouring spout 16 also preferably minimizes the speed at which liquid is removed from the vessel 12 since the liquid is all preferably directed through the pouring spout 16 as opposed to generally flowing over the top edge 18, thereby limiting the risk of injury from boiling or heated liquids and the mess associated therewith.

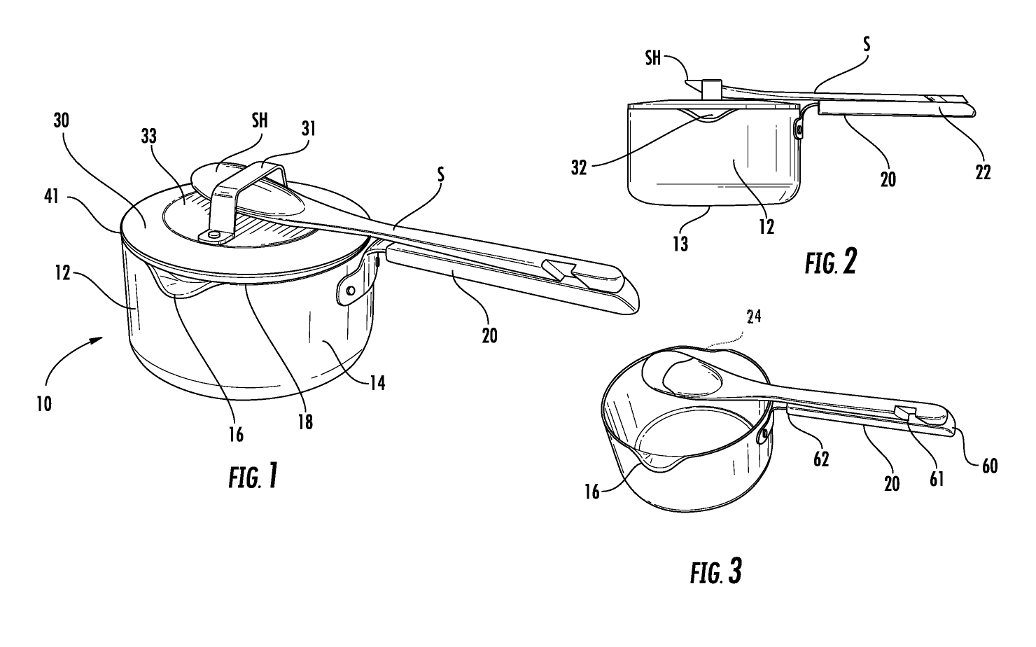

A cover or lid 30 is shaped and sized to securely and easily fit on and within the wall 14 so that a top edge 18 of the pot serves as a support for a bulbous circumferential edge 41 to the cover. This, too, is quite conventional. This will substantially maintain the heat within the cavity or holding portion of the pot, as desired. The lid or cover 30 is provided with a handle 31. As can be seen in FIGS. 1 and 2, the handle 31 is elevated well above the top surface of lid 30 not only to allow a user's fingers of a hand to easily go under to ease movement of the lid/cover 30 but also to allow a spoon head SH of a spoon S, suspended laterally on the handle 20 of the pot 10, to be located there. The top surface of the lid or cover 30 is provided with a depressed central area 33 so that drippings of hot food from the spoon head SH will drip and be retained there and, in this manner, when the user moves the lid or cover another time, the back of his/her hand will not come into contact with the drippings.

The lid is provided on its underside with a circumferential, downwardly extending flange just inside the circumferential edge 41. The diameter of the flange 43 is slightly less than the inside diameter of the side wall 14. The flange extends within the vessel a distance, along the side wall 14, and maintains the lid 30 on the pot 10, even while the pot is tilted for pouring liquid out through the spout 16. In effect, the flange and the lid seal off airflow into and out of vessel 12 during cooking. However, lid 30 and, specifically, a section of the flange 43, just a bit more in circumferential length than the distance across the spout, is provided with apertures 50. These apertures, when aligned with the spout 16, allow fluid in the pot, when the same is tilted, to be poured out and through the spout. If the aperture section or the strainer of the flange is not aligned with the spout, then no liquid will be poured out even as the pot is tilted as the flow of liquid will be blocked by the mechanical interaction of the flange and the lid covering the pot and its spout.

In the preferred embodiment, the flange 43 extends down from the edge 41 to at least the bottom of the spout as it connects to the side wall of the pot. More preferably, the flange extends to about 25% of the height of the side wall of the pot. But, of course, the side wall of the pot is tapered inwardly so that food stuff on the inside wall will tend to slide into the bottom of the pot and not remain on the side wall. The size and shape of the apertures are variable by the manufacturer but need to be sufficient to allow for water or fluid drain off, as desired, and, yet, retain the more solid food within the pot, during tilting for straining and liquid draw off.

The flange extends downwardly into the pot and along the inside side wall so that the pot can be tilted at a large angle, to maximize liquid pouring from the pot, through the spout, and, yet, the cover or lid will be maintained thereon. Of course, the user can also hold the handle of the lid so that the lid is held onto the pot during pouring and, in that manner, the flange's extension can be reduced but not so reduced that it does not extend below the bottom of the spout.

IN the preferred embodiment, the strainer section (that part of the flange provided with apertures) is aligned with the handle so that a user easily and intuitively knows when the strainer is aligned with the spout and, correspondingly, when the strainer section of the flange is out of alignment with the spout. In an alternate embodiment, a second strainer section can be provided to the flange, opposed to the first and again aligned with the handle.

The top of the flange bearing strainer section 32 can be seen in FIG. 2. When aligned with the pouring spout 16, the strainer allows liquid to flow into and out of the spout. When the lid is rotated so that the strainer section is not aligned with the pouring spout, the flange substantially blocks or prevents liquid from exiting the vessel 12. The flange serves to seal off the vessel 12 to prevent hot air from being released through the side spout during cooking. Thus, aperture section or the strainer acts as and replaces a separate colander in a kitchen, thereby eliminating the need for an entirely separate kitchen tool for straining liquid.

Pot 10 also comprises a pot-holding handle 20 longitudinally extending outwardly from vessel 12 and preferably forming a 90 degree angle (see FIG. 2) to the side wall. Handle 20 has a bottom surface which is easy and comfortable to grip, allowing the pot to be easily moved onto and off of the cooking surface.

On the top surface of the handle 20, a concave surface 61 extends from the proximal end 60 to the distal end 62 (defined for present purposes as the end closest to the sidewall of the pot). That concave surface 61 extending along the length of the top surface of the handle 20 is shaped and configured to hold the handle of a standard-sized cooking utensil, such as a cooking spoon. Handle 20 is preferably long enough to hold a majority of the length of the handle of a cooking spoon thereon to prevent the spoon from falling off of handle 20 and into the vessel 12 during cooking. Side walls 22 of the surface 61 are designed to extend upwardly from base 26 to retain the handle of the cooking spoon, which is often cylindrical and rounded in shape.

As mentioned, the handle of a spoon S can be located on the handle 20 of the pot and the spoon head SH can overly the center of the pot so that dripping of the food after the spoon is used will be into the pot, creating a mess-less condition (see FIG. 3). In an alternate condition, when the pot is provided with its lid, the spoon S and its spoon head SH are slid under and retained on the pot and lid with the spoon head SH placed beneath the handle 31 of the lid. As mentioned, the food drippings from the spoon head SH will then fall into the recess 33 of the lid. This can be easily accomplished by having the handle of the lid in its aligned orientation, i.e., with the strainer aligned with the pouring spout. In that orientation, the handle of the lid extends across the axis defined by the handle of the pot and the spoon can be easily placed on the handle of the pot and the spoon head beneath the handle of the lid (as shown in FIGS. 1 and 2).

Thus, the present invention pot 10 comprises vessel 12 with lid 30 which are the components of a traditional pot. However, pot 10 also comprises strainer section on the flange of lid 30 which, when aligned with pouring spout 16 on the vessel 12, is configured to act as a colander or strainer for liquid in vessel 12. Finally, pot 10 comprises handle 20 which is configured on its top surface 61 to act as a spoon rest for a cooking spoon S or other cooking utensil, and comprises a slightly concave structure with side walls 22 which are configured to hold the cooking utensil in place. Thus, the present invention pot 10 comprises the structural components and functional features of a traditional pot, a colander, and a spoon rest all in a single embodiment, thereby reducing the amount of kitchen tools required for cooking and for storage.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

1. A pot for cooking, comprising:
a food holding vessel defined by a bottom and a cylindrical sidewall extending upwardly therefrom, said side wall having an upper edge extending substantially around the circumference of said vessel, said edge configured and comprising an outwardly extending pouring spout;
a lid with a first U-shaped handle, configured to be supported on said vessel at said upper edge, said lid comprising a downwardly extending flange of slightly less diameter than the inside diameter of said sidewall and configured to securely fit within the sidewall of said vessel, said flange comprising a fluid strainer section formed by one or more apertures therein;
said first handle being an inverted U-shape and having a a bight section elevated above the lid to an extent that a head of a cooking spoon may be laterally passed through and suspended underneath; and
a second handle, extending outwardly from said vessel, said second handle having an upwardly concave-shaped top surface.

2. A pot as claimed in claim 1, wherein said downwardly extending flange of said lid is about 25% of the height of said sidewall.

3. A pot as claimed in claim 1 wherein said strainer section is aligned with legs and bight section of said first handle.

4. (canceled)

5. (canceled)

6. A pot as claimed in claim 1, wherein said second handle has a length substantially equal to the length of a standard cooking spoon.

7. A pot as claimed in claim 1 wherein said second handle is no less than about ½ of the length of a standard cooking spoon.

8. A pot as claimed in claim 1 wherein a second pouring spout is located on said vessel, across from said first pouring spout.

9. A spot as claimed in claim 1 wherein said pouring spout is located at about 90 degrees around said sidewall from a longitudinal axis defined by said second handle.
